(19) United States
(12) Patent Application Publication
(10) Pub. No.: US 2022/0164467 A1
(43) Pub. Date: May 26, 2022

(54) DATA QUERY METHOD, SHARED DEVICE, AND QUERY DEVICE OF BLOCKCHAIN SYSTEM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN LU, Shenzhen (CN); ZE-PENG CAI, Shenzhen (CN)

(21) Appl. No.: 17/344,108

(22) Filed: Jun. 10, 2021

(30) Foreign Application Priority Data
Nov. 20, 2020 (CN) 202011308755.X

(51) Int. Cl. G06F 21/62; G06F 16/23; G06F 16/245; G06F 21/60; H04L 9/32; H04L 9/30

(52) U.S. Cl. CPC G06F 21/6227; G06F 16/2379; G06F 16/245; H04L 2209/38; H04L 9/3239; H04L 9/30; G06F 21/602

(57) ABSTRACT

A data query method includes receiving query data from a query device and verifying whether the query data is authorized, obtaining shared data corresponding to the query data in response that the query data is authorized, performing a logical judgment on the query data and the shared data corresponding to the query data and obtaining a query result corresponding to the query data, encrypting the query result corresponding to the query data, and sending the encrypted query result to the query device. The query device decrypts the query result according to a decryption rule. The query result is a preset logical judgment result. A shared device and a query device of a blockchain system are also provided.

### FIELD

The subject matter herein generally relates to blockchain systems, and more particularly to a data query method, a shared device, and a query device of a blockchain system.

### BACKGROUND

In daily life, there are many scenarios that require inspection of personal information. However, personal information is easy to be leaked.

### BRIEF DESCRIPTION OF THE DRAWINGS

Implementations of the present application will now be described, by way of embodiments, with reference to the attached figures.

FIG. 1 is a schematic diagram of an application environment architecture of a data query method according to an embodiment of the present application.

FIG. 2 is a flowchart of the data query method according to an embodiment of the present application.

FIG. 3 is a schematic diagram of a blockchain system according to an embodiment of the present application.

FIG. 4 is a schematic diagram of a shared device according to an embodiment of the present application.

FIG. 5 is a schematic diagram of a query device according to an embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this application will now be presented.

The term “comprising” means “including, but not necessarily limited to”; it specifically indicates open-ended inclusion or membership in a so-described combination, group, series, and the like.

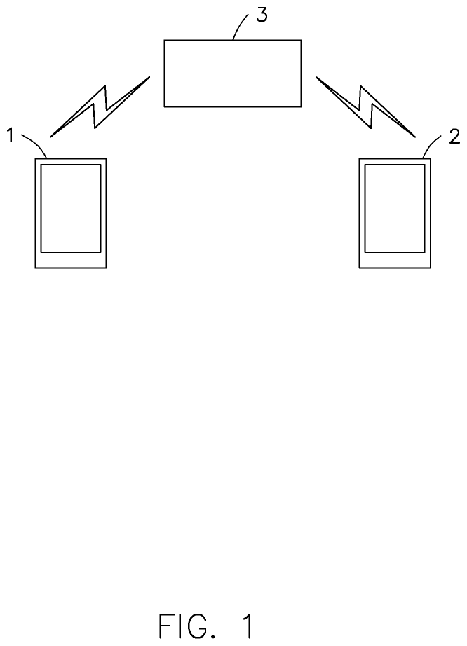

FIG. 1 is a schematic diagram of an application environment architecture of a data query method provided in an embodiment of the present application. A shared device 1 and a query device 2 are in communication with a blockchain system 3 through a network. The network may be a wired network or a wireless network, such as radio, wireless fidelity (Wi-Fi), cellular, etc.

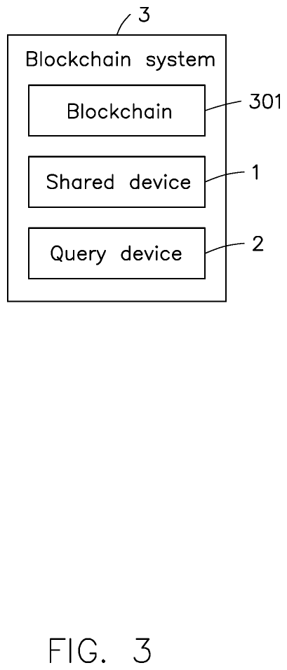

Referring to FIG. 3, in another embodiment, the shared device 1 and the query device 2 form the blockchain system 3 through the network. Both the shared device 1 and the query device 2 are nodes of the blockchain system 3. In one embodiment, the blockchain system 3 includes at least one blockchain 301 for storing shared data and/or query data of each node.

The shared device 1 may be an electronic device, such as a personal computer, a server, etc. installed with a data query program. The server may be a single server, a server cluster, or a cloud server. The shared device 1 is used for sharing data.

The query device 2 may also be an electronic device, such as a personal computer, a server, etc. installed with a data sharing authorization program for applying to query the shared data of the shared device 1.

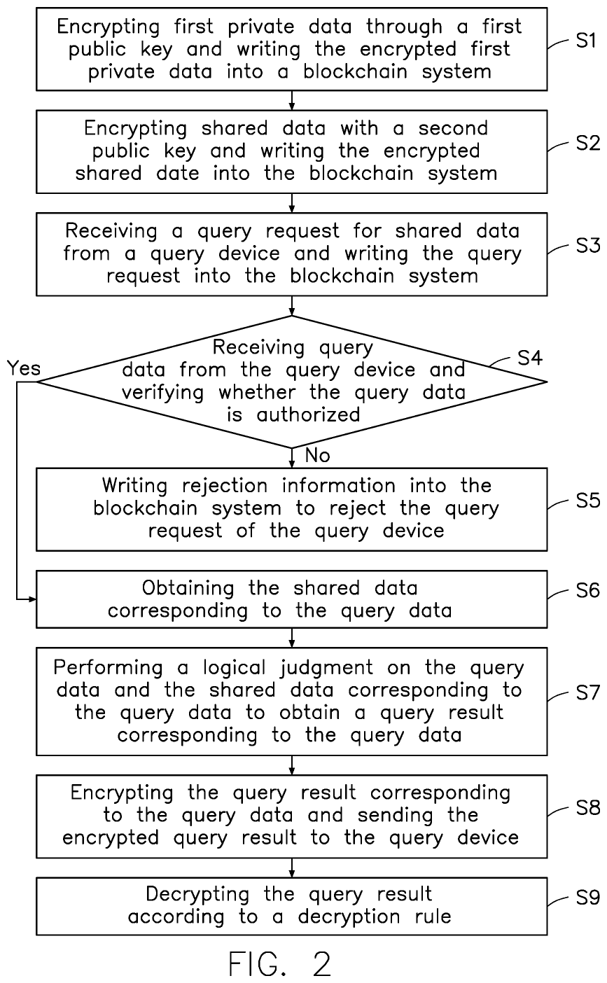

FIG. 2 shows a flowchart of a data query method provided by an embodiment of the present application. According to different requirements, the order of blocks in the flowchart can be changed, and some blocks can be omitted or combined.

At block S1, first private data is encrypted through a first public key and written into the blockchain system 3.

In one embodiment, the first private data is a user's identification information. The first private data may include, but is not limited to, the user's name, ID number, work number, facial image, and fingerprint information. The first public key is generated by the shared device 1 through an encryption algorithm of a first private key.

In one embodiment, the shared device 1 encrypts the first private data through the first public key and writes the first private data into the blockchain 301, and then shares the first public key to the blockchain system 3.

At block S2, shared data is encrypted through a second public key and written into the blockchain system 3.

In one embodiment, the shared data includes the first private data and data to be checked of a plurality of users. The first private data has been encrypted through the first public key. The data to be checked can be customized according to the user of the shared device 1. For example, if the user of the shared device 1 is an enterprise, the data to be checked may include employment information, salary, seniority, education, and a training duration of employees of the enterprise. If the user of the shared device 1 is a business unit, the data to be checked may include a marital status, family status, and permanent residence address of a resident.

In one embodiment, the second public key is generated by the shared device 1 through an encryption algorithm of a second private key. The shared device 1 encrypts the shared data through the second public key and writes the shared data into the blockchain 301. After the shared data is written into the blockchain 301, the blockchain system 3 returns a unique data code to the shared device 1 to identify the shared data of the shared device 1.

At block S3, a query request for shared data is received from the query device 2 and written into the blockchain system 3.

In one embodiment, the query request includes a query date and an identification number of the query device 2. The identification number is used to represent the identity information of the user corresponding to the query device 2, such as the name of the user, the name of the business unit, the name of the enterprise, and so on.

In one embodiment, the blockchain system 3 receives the query request for shared data sent by the query device 2, writes the query request into the blockchain 301, and responds to the query request by sending a query number to the query device 2.

At block S4, query data is received from the query device 2, and whether the query data is authorized is verified.

In one embodiment, the query data includes, but is not limited to, the query number, a third public key of the query device 2, and verification data. The verification data includes second private data and query questions. The second private data includes at least one of the first private data, such as the ID number, work number, and/or fingerprint information of an enterprise employee. The third public key is generated by the query device 2 through an encryption algorithm of the third private key.

In one embodiment, a memory of the shared device 1 stores an authorization list and a user database. The authorization list is used to store the identification numbers of individuals, business units, or enterprises that have been authorized by the shared device 1 to inspect user data, and the user database is used to store the data to be inspected and a user information table of each user. The user information table is used to record a corresponding relationship between a data code of each user and the first private data. Thus, the data to be checked for each user in the shared data has a corresponding data code.

In one embodiment, the query device 2 first sends the query number and the third public key to the blockchain system 3. When the blockchain system 3 determines that the query number in the query data is the same as the sent query number, the blockchain system 3 sends a prompt message to the query device 2 to prompt a user of the query device 2 to enter the second private data and a query question. When the query device 2 receives the prompt information, the query device 2 sends the second private data and query question input by the user to the blockchain system 3. The query device 2 may encrypt the query number and the verification data through the third public key and then write the encrypted query number and verification data into the blockchain 301. In other embodiments, the query device 2 may also send the query number, the third public key, and the verification data to the blockchain system 3 together.

In one embodiment, the blockchain system 3 uses the third public key to decrypt and obtain the identification number of the query device 2 from the blockchain 301 and sends the identification number of the query device 2 and the second private data to the shared device 1. The shared device 1 determines whether the identification number of the query device 2 is included in the authorization list. In response that the identification number of the query device 2 is included in the authorization list, it is determined that the query data is authorized, and then block S6 is implemented. In response that the identification number of the query device 2 is not included in the authorization list, it is determined that the query data is not authorized, and then block S5 is implemented.

At block S5, rejection information is written into the blockchain system 3 to reject the query request of the query device 2.

In one embodiment, in response that the shared device 1 determines that the identification number of the query device 2 is not included in the authorization list, the shared device 1 determines that the query data is not authorized and writes the rejection information into the blockchain 301. The blockchain system 3 further sends the rejection information to the query device 2 to reject the query request of the query device 2.

At block S6, the shared data corresponding to the query data is obtained.

In one embodiment, in response that the query data is authorized, the shared device 1 compares the second private data to the first private data to determine whether the second private data matches any of the first private data of the user. For example, the shared device 1 determines whether the employee name, ID number, and job number in the second private data respectively match any one of the employee name, ID number, and job number in the first private data of the user. In response that it is determined that the second private data matches any of the first private data of the user, the shared device 1 obtains the data number corresponding to the user from the user information table, and then sends the obtained data number and the second private key to the blockchain system 3. In response that it is determined that the second private data does not match any of the first private data of the user, the shared device 1 sends the second private key to the blockchain system 3.

In one embodiment, when the blockchain system 3 receives the data number and the second private key, the shared data of the user corresponding to the data number is obtained from the blockchain 301, and the obtained shared data corresponding to the query data is decrypted through the second private key.

In one embodiment, when the blockchain system 3 only receives the second private key, all of the shared data of the shared device 1 is obtained from the blockchain 301, and then the obtained shared data is decrypted through the second private key to obtain the shared data corresponding to the query data.

In one embodiment, the shared data written by the shared device 1 into the blockchain system 3 includes a plurality of data types. For example, the data types may include basic data, performance data, education and training data, other data, and so on. The blockchain system 3 analyzes the data type to which the query question in the verification data belongs, and then obtains the corresponding shared data according to the data type obtained by the analysis and the data number, or only according to the data type obtained by the analysis, and then decrypts the obtained shared data corresponding to the query data through the second private key.

At block S7, a logical judgment is performed on the query data and the shared data corresponding to the query data, and a query result corresponding to the query data is obtained.

In one embodiment, in block S7, the blockchain system 3 further encrypts the second private data in the verification data through the first public key of the shared device 1.

In one embodiment, the blockchain system 3 performs the logical judgment on the query question in the verification data and the shared data obtained by decryption and obtains the query result. The query result is a preset logical judgment result. The preset logical judgment result includes “yes”, “no”, and “uncertain”.

For example, if the query question is “Is this employee an official employee of your company”, the blockchain system 3 determines whether the shared data obtained by decryption includes the employee's job information. When it is determined that the shared data includes the employee's job information, the result of the logical judgment is “yes”. When it is determined that the shared data does not contain the employee's job information, the result of the logical judgment is “no”, and the final result of the logical judgment is sent to the query device 2, and specific information of the employee will not be directly disclosed to the query device 2.

In another example, if the query question is “does the employee's annual salary reach 200,000”, the blockchain system 3 determines whether the employee's salary in the shared data obtained by decryption is more than 200,000. When it is determined that the salary of the employee in the shared data is more than 200,000, the result of the logical judgment is “yes”. When it is determined that the salary of the employee in the shared data is less than 200,000, the result of the logical judgment is “no”. When it is determined that the salary information of the employee is not included in the shared data, the result of the logical judgment is “uncertain”, and the final result of the logical judgment is sent to the query device 2 without directly disclosing the specific salary of the employee to the query device 2.

At block S8, the query result corresponding to the query data is encrypted, and the encrypted query result is sent to the query device 2.

In one embodiment, the blockchain system 3 encrypts the query result through the third public key of the query device 2 and sends the encrypted query result to the query device 2.

At block S9, the query device 2 decrypts the query result according to a decryption rule.

In one embodiment, the decryption rule is that the query device 2 uses the third private key corresponding to the third public key to decrypt the query result. That is, after receiving the encrypted query result, the query device 2 uses the third private key corresponding to the third public key to decrypt the query result to obtain the query result.

The data query method provided by the present application can automatically query user data without directly providing specific user data to the query terminal, and the user data is kept encrypted, which effectively guarantees the security and authenticity of the user data during the data query process.

FIG. 3 shows a schematic structural diagram of a blockchain system 3 according to an embodiment of the present application. The blockchain system 3 includes, but is not limited to, a blockchain 301, at least one shared device 1, and at least one query device 2.

The shared device 1 encrypts the first private data through a first public key, writes the encrypted first private data into the blockchain system 3, and shares the first public key to the blockchain system 3.

In one embodiment, the first private data is a user's identification information. The first private data may include, but is not limited to, the user's name, ID number, work number, facial image, and fingerprint information. The first public key is generated by the shared device 1 through an encryption algorithm of a first private key.

In one embodiment, the shared device 1 encrypts the first private data through the first public key, writes the encrypted first private data into the blockchain 301, and shares the first public key to the blockchain system 3.

The shared device 1 encrypts the shared data through the second public key and writes the encrypted shared data into the blockchain system 3.

In one embodiment, the shared data includes the first private data and data to be checked of a plurality of users. The first private data has been encrypted by the first public key. The data to be checked can be customized according to the user of the shared device 1. For example, if the user of the shared device 1 is an enterprise, the data to be checked may include employment information, salary, seniority, education, and a training duration of employees of the enterprise. If the user of the shared device 1 is a business unit, the data to be checked may include a marital status, family status, and permanent residence address of a resident.

In one embodiment, the second public key is generated by the shared device 1 through an encryption algorithm of the second private key. The shared device 1 encrypts the shared data through the second public key and writes the encrypted shared data into the blockchain 301. After the shared data is written into the blockchain 301, the blockchain system 3 returns a unique data code to the shared device 1 to identify the shared data of the shared device 1.

The query device 2 sends a query request for shared data and writes the query request into the blockchain system 3.

In one embodiment, the query request includes a query date and an identification number of the query device 2. The identification number is used to represent the identity information of the user corresponding to the query device 2, such as the name of the user, the name of the business unit, the name of the enterprise, and so on.

In one embodiment, the blockchain system 3 receives the query request for shared data sent by the query device 2, writes the query request into the blockchain 301, and responds to the query request by sending a query number to the query device 2.

The blockchain system 3 receives the query data from the query device 2 and verifies whether the query data is authorized.

In one embodiment, the query data includes, but is not limited to, the query number, a third public key of the query device 2, and verification data. The verification data includes second private data and query questions. The second private data includes at least one of the first private data, such as the ID number, work number, and/or fingerprint information of an enterprise employee. The third public key is generated by the query device 2 through an encryption algorithm of the third private key.

In one embodiment, a memory of the shared device 1 stores an authorization list and a user database. The authorization list is used to store the identification numbers of individuals, business units, or enterprises that have been authorized by the shared device 1 to inspect user data, and the user database is used to store the data to be inspected and a user information table of each user. The user information table is used to record a corresponding relationship between a data code of each user and the first private data. Thus, the data to be checked for each user in the shared data has a corresponding data code.

In one embodiment, the query device 2 first sends the query number and the third public key to the blockchain system 3. In response that the blockchain system 3 determines that the query number in the query data is the same as the sent query number, the blockchain system 3 sends a prompt message to the query device 2 to prompt a user of the query device 2 to enter the second private data and a query question. In response that the query device 2 receives the prompt information, the query device 2 sends the second private data and query question input by the user to the blockchain system 3. The query device 2 may encrypt the query number and the verification data through the third public key and then write the encrypted query number and verification data into the blockchain 301. In other embodiments, the query device 2 may also send the query number, the third public key, and the verification data to the blockchain system 3 together.

In one embodiment, the blockchain system 3 uses the third public key to decrypt and obtain the identification number of the query device 2 from the blockchain 301 and sends the identification number of the query device 2 and the second private data to the shared device 1. The shared device 1 determines whether the identification number of the query device 2 is included in the authorization list. In response that the identification number of the query device 2 is included in the authorization list, it is determined that the query data is authorized. In response that the identification number of the query device 2 is not included in the authorization list, it is determined that the query data is not authorized.

In one embodiment, in response that the shared device 1 determines that the identification number of the query device 2 is not included in the authorization list, the shared device 1 determines that the query data is not authorized and writes the rejection information into the blockchain 301. The blockchain system 3 further sends the rejection information to the query device 2 to reject the query request of the query device 2.

The blockchain system 3 further obtains shared data corresponding to the query data.

In one embodiment, in response that it is determined that the query data is authorized, the shared device 1 compares the second private data to the first private data to determine whether the second private data matches any of the first private data of the user. For example, the shared device 1 determines whether the employee name, ID number, and job number in the second private data respectively match any one of the employee name, ID number, and job number in the first private data of the user. When it is determined that the second private data matches any of the first private data of the user, the shared device 1 obtains the data number corresponding to the user from the user information table, and then sends the obtained data number and the second private key to the blockchain system 3. When it is determined that the second private data does not match any of the first private data of the user, the shared device 1 sends the second private key to the blockchain system 3.

In response that the blockchain system 3 receives the data number and the second private key, the shared data of the user corresponding to the data number is obtained from the blockchain 301, and the obtained shared data corresponding to the query data is decrypted through the second private key.

In one embodiment, in response that the blockchain system 3 only receives the second private key, all of the shared data of the shared device 1 is obtained from the blockchain 301, and then the obtained shared data is decrypted through the second private key to obtain the shared data corresponding to the query data.

In one embodiment, the shared data written by the shared device 1 into the blockchain system 3 includes a plurality of data types. For example, the data types may include basic data, performance data, education and training data, other data, and so on. The blockchain system 3 analyzes the data type to which the query question in the verification data belongs, and then obtains the corresponding shared data according to the data type obtained by the analysis and the data number, or only according to the data type obtained by the analysis, and then decrypts the obtained shared data corresponding to the query data through the second private key.

The blockchain system 3 performs a logical judgment on the query data and the shared data corresponding to the query data and obtains a query result corresponding to the query data.

In one embodiment, the blockchain system 3 further encrypts the second private data in the verification data through the first public key of the shared device 1.

In one embodiment, the blockchain system 3 performs the logical judgment on the query question in the verification data and the shared data obtained by decryption to obtain the query result. The query result is a preset logical judgment result. The preset logical judgment result includes “yes”, “no”, and “uncertain”.

For example, if the query question is “Is this employee an official employee of your company”, the blockchain system 3 determines whether the shared data obtained by decryption includes the employee's job information. When it is determined that the shared data includes the employee's job information, the result of the logical judgment is “yes”. When it is determined that the shared data does not contain the employee's job information, the result of the logical judgment is “no”, and the final result of the logical judgment is sent to the query device 2, and specific information of the employee will not be directly disclosed to the query device 2.

In another example, if the query question is “does the employee's annual salary reach 200,000”, the blockchain system 3 determines whether the employee's salary in the shared data obtained by decryption is more than 200,000. When it is determined that the salary of the employee in the shared data is more than 200,000, the result of the logical judgment is “yes”. When it is determined that the salary of the employee in the shared data is less than 200,000, the result of the logical judgment is “no”. When it is determined that the salary information of the employee is not included in the shared data, the result of the logical judgment is “uncertain”, and the final result of the logical judgment is sent to the query device 2 without directly disclosing the specific salary of the employee to the query device 2.

The blockchain system 3 further encrypts the query result corresponding to the query data and sends the encrypted query result to the query device 2.

In one embodiment, the blockchain system 3 encrypts the query result through the third public key of the query device 2 and sends the encrypted query result to the query device 2.

The query device 2 decrypts the query result according to a decryption rule.

In one embodiment, the decryption rule is that the query device 2 uses the third private key corresponding to the third public key to decrypt the query result. That is, after receiving the encrypted query result, the query device 2 uses the third private key corresponding to the third public key to decrypt the query result to obtain the query result.

The blockchain system 3 provided by the present application can automatically query user data without directly providing specific user data to the query terminal, and the user data is kept encrypted, which effectively guarantees the security and authenticity of the user data during the data query process.

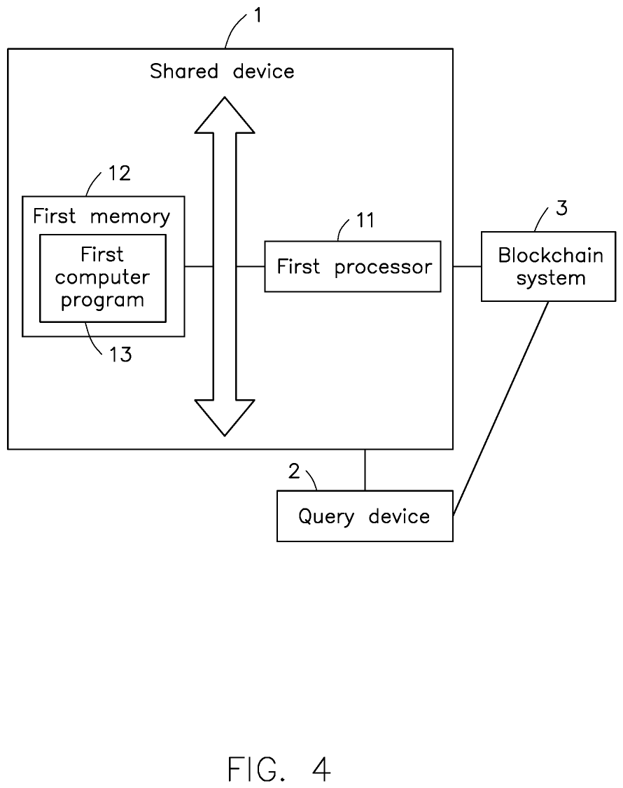

FIG. 4 shows a schematic diagram of a shared device 1 according to an embodiment of the present application.

The shared device 1 includes, but is not limited to, a first processor 11 and a first memory 12, and a first computer program 13 is stored in the first memory 12 and executed by the first processor 11. For example, the first computer program 13 may be a data query program. The first processor 11 may implement some or all of the blocks in the data query method when the first computer program 13 is executed.

Specifically, the shared device 1 accesses the blockchain system 3. When the first processor 11 executes the first computer program 13, the following method is implemented:

Receiving the query data from the query device 2 and verifying whether the query data is authorized; and

In response that the query data is authorized, sending a private key and a data number corresponding to the query data to the blockchain system 3.

The blockchain system 3 obtains the encrypted shared data according to the data number, decrypts the shared data through the private key, performs a logical judgment on the query data and the decrypted shared data, obtains a query result corresponding to the query data, and sends an encrypted query result to the query device 2. The query result is a preset logical judgment result.

In one embodiment, the first computer program 13 may be a series of computer program instruction segments capable of completing specific functions, and the instruction segments are used to describe the execution process of the first computer program 13 in the shared device 1.

Those skilled in the art will understand that the schematic diagram is only an example of the shared device 1 and does not constitute a limitation of the shared device 1. The shared device 1 may include more or less components than those shown in FIG. 4, have a combination of certain components, or have different components. For example, the shared device 1 may also include input and output devices, network access devices, buses, and so on.

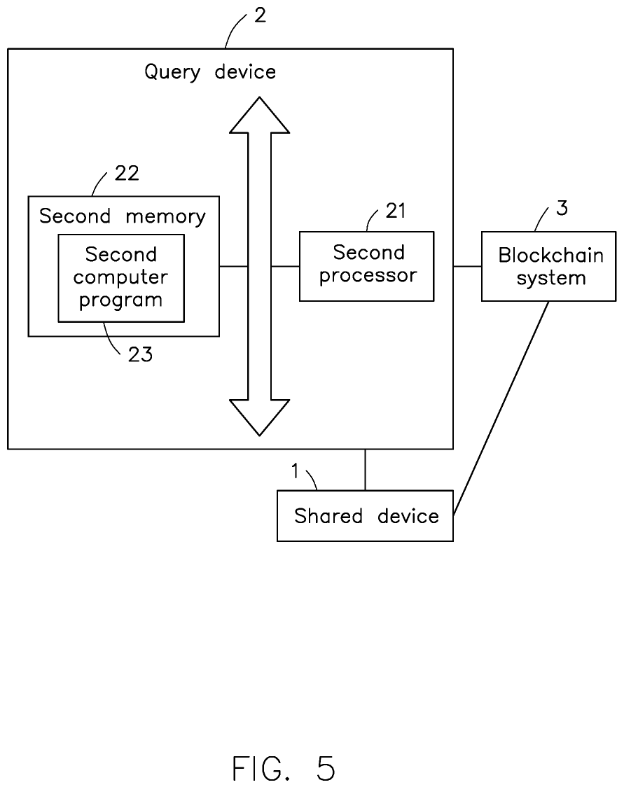

FIG. 5 shows a schematic diagram of a query device 2 according to an embodiment of the present application.

The query device 2 includes, but is not limited to, a second processor 21 and a second memory 22, and a second computer program 23 is stored in the second memory 22 and executed by the second processor 21. For example, the second computer program 23 may be a data query program. When the second processor 21 executes the second computer program 23, some or all blocks of the data query method may be implemented.

Specifically, the query device 2 accesses the blockchain system 3. When the second processor 21 executes the second computer program 23, the following method is implemented:

Sending query data of shared data to the blockchain system 3;

Receiving an encrypted query result from the blockchain system 3; and Decrypting the query result according to a decryption rule. The query result is a preset logical judgment result.

In response that the query data is authorized, the blockchain system 3 obtains the shared data corresponding to the query data, performs a logical judgment on the query data and the shared data corresponding to the query data, and obtains the query result corresponding to the query data.

Those skilled in the art will understand that the schematic diagram is only an example of the query device 2 and does not constitute a limitation of the query device 2. The query device 2 may include more or less components than those shown in FIG. 5, may include a combination of certain components, or have different components. For example, the query device 2 may also include input and output devices, network access devices, buses, and so on.

The first processor 11 and the second processor 21 may be a central processing unit, and may also be other general-purpose processors, digital signal processors, application specific integrated circuits, ready-made programmable gate array or other programmable logic devices, discrete gates or transistor logic devices, discrete hardware components, etc. The general-purpose processor may be a microprocessor or any conventional processor. The first processor 11 is a control center of the shared device 1 and uses various interfaces and lines to connect various parts of the entire shared device 1. The second processor 21 is a control center of the query device 2 and connects various parts of the entire query device 2 through various interfaces and lines.

The first memory 12 and the second memory 22 can be used to store the computer programs. The first memory 12 and the second memory 22 may be volatile memories, and may also include non-volatile memories, such as hard disks, plug-in hard disks, smart media cards, secure digital cards, flash cards, at least one disk storage device, flash memory device, or another storage device.

The embodiments shown and described above are only examples. Even though numerous characteristics and advantages of the present technology have been set forth in the foregoing description, together with details of the structure and function of the present application, the application is illustrative only, and changes may be made in the detail, including in matters of shape, size and arrangement of the parts within the principles of the present application up to, and including, the full extent established by the broad general meaning of the terms used in the claims.

What is claimed is:

1. A data query method of a blockchain system, the data query method comprising:
receiving query data from a query device and verifying whether the query data is authorized;
in response that the query data is authorized, obtaining shared data corresponding to the query data;
performing a logical judgment on the query data and the shared data corresponding to the query data and obtaining a query result corresponding to the query data, the query result being a preset logical judgment result;
encrypting the query result corresponding to the query data; and
sending the encrypted query result to the query device, which decrypts the query result according to a decryption rule.

2. The data query method of claim 1, further comprising:
receiving a query request for shared data from the query device and writing the query request into the blockchain system; and
in response to the query request, sending a query number to the query device.

3. The data query method of claim 2, wherein:
the query data comprises the query number, a public key of the query device, and verification data.

4. The data query method of claim 3, wherein obtaining the shared data corresponding to the query data comprises:
in response that the query data is authorized, receiving a private key sent by a shared device and a data number corresponding to the query data; and
obtaining encrypted shared data from the blockchain system according to the data number and decrypting the encrypted shared data through the private key.

5. The data query method of claim 4, wherein performing the logical judgment on the query data and the shared data corresponding to the query data and obtaining the query result corresponding to the query data comprises:
encrypting private data in the verification data through a public key of the shared device; and
performing the logical judgment on the verification data and the decrypted shared data and obtaining the query result.

6. The data query method of claim 5, wherein encrypting the query result corresponding to the query data comprises:
encrypting the query result through the public key of the query device; wherein:
the query device decrypts the query result through the private key corresponding to the public key of the query device.

7. A shared device of a blockchain system, the shared device comprising:
a first processor; and
a first memory that stores a plurality of instructions, which when executed by the first processor, causing the first processor to:
receive query data from a query device and verify whether the query data is authorized; and
in response that the query data is authorized, send a private key and a data number corresponding to the query data to the blockchain system.

8. The shared device of the blockchain system of claim 7, wherein the first processor is further caused to:
receive a query request for shared data from the query device and write the query request into the blockchain system; and
in response to the query request, send a query number to the query device.

9. The shared device of the blockchain system of claim 8, wherein the query data comprises the query number, a public key of the query device, and verification data.

10. The shared device of the blockchain system of claim 9, wherein the first processor is further caused to:
in response that the query data is authorized, receive a private key sent by the shared device and a data number corresponding to the query data; and
obtain encrypted shared data from the blockchain system according to the data number and decrypt the encrypted shared data through the private key.

11. The shared device of the blockchain system of claim 10, wherein the first processor is further caused to:
encrypt private data in the verification data through a public key of the shared device; and
perform the logical judgment on the verification data and the decrypted shared data and obtain the query result.

12. The shared device of the blockchain system of claim 11, wherein the first processor encrypts the query result through the public key of the query device, and the query device decrypts the query result through the private key corresponding to the public key of the query device.

13. A query device of a blockchain system, the query device comprising:
a second processor; and
a second memory that stores a plurality of instructions, which when executed by the second processor, causing the second processor to:
send query data corresponding to shared data to the blockchain system;
receive an encrypted query result from the blockchain system; and
decrypt the query result according to a decryption rule.

14. The query device of claim 13, wherein:
the query result is a preset logical judgment result.
